(19) United States
(12) Patent Application Publication
(10) Pub. No.: US 2018/0309966 A1
(43) Pub. Date: Oct. 25, 2018

(54) PROJECTION APPARATUS AND CONTROL METHOD THEREFOR

(71) Applicant: CANON KABUSHIKI KAISHA, Tokyo (JP)

(72) Inventor: Junji Kotani, Inagi-shi (JP)

(21) Appl. No.: 15/955,840

(22) Filed: Apr. 18, 2018

(30) Foreign Application Priority Data
Apr. 24, 2017 (JP) 2017-085241

(51) Int. Cl. H04N 9/31

(52) U.S. Cl. CPC H04N 9/3105; H04N 9/3182

(57) ABSTRACT

A projection apparatus that projects a projection image of invisible light onto a projection plane, the projection apparatus includes: a light source configured to emit light including invisible light; a projecting unit configured to project the projection image by modulating light emitted from the light source based on input image data; a first acquiring unit configured to acquire first characteristic information indicating a wavelength conversion characteristic of goggles that convert a wavelength of the projection image and output an image of visible light to a user; and an adjusting unit configured to adjust brightness of the projection image on the projection plane based on the first characteristic information.

### BACKGROUND OF THE INVENTION

### Field of the Invention

The present invention relates to a projection apparatus and a control method therefor.

### Description of the Related Art

A simulator for training to function at night in a state of wearing a night vision device has been used. Generally a projection apparatus using an infrared light source is used for the simulator for night training. This projection apparatus can generate a pseudo-night image by projecting and displaying an image of an infrared light (hereafter also called “IR light”). The training can be performed by observing this image using a night vision device, such as night vision goggles (NVG), which converts infrared light into visible light.

Japanese Patent Application Publication No. 2010-140017 discloses a technique to implement this projection apparatus. Japanese Patent Application Publication No. 2010-140017 discloses a system which includes: a visible light source and an invisible light source; a light modulator configured to receive and modulate the respective lights and form an image; and a projection optical system configured to align and simultaneously project the visible image and the invisible image.

To improve the effect of this type of training, the image that is observed via the night vision device during the training is preferably close to an image that is observed via the night vision device in an actual environment. For example, the brightness of the image observed via the night vision device during the training is preferably close to that in an actual environment. Japanese Patent Application Publication No. 2010-81001 discloses a stereoscopic vision device which includes a camera to capture the respective images of a visible wavelength region and an invisible region, and a display that displays an image based on the images captured by the camera, and in which the camera and the display are disposed in opposite directions. As a technique to adjust the brightness when the invisible light is converted into visible light, Japanese Patent Application Publication No. 2010-81001 discloses a stereoscope vision device which includes a controller to adjust the brightness and contrast of the display.

In some cases, an image that is observed via the night vision device may not be seen at a desired brightness when the night training simulator is first installed. In other cases, even if an image that is observed via the night vision device was seen at a desired brightness when the night training simulator was first installed, the brightness may change when parts of the simulator are replaced or deteriorate over time.

Further, when the wavelength of the IR light, which is assumed when the IR image contents are created and the wavelength of the IR light projected by the projection apparatus are different, the IR image may be seen via the night vision device at an unexpected brightness. In such cases, the brightness must be adjusted. If the technique disclosed in Japanese Patent Application Publication No. 2010-81001 is used, the brightness and contrast can be adjusted at the night vision device side, whereby the brightness can be changed as desired.

However, in the case of Japanese Patent Application Publication No. 2010-81001, the technique to adjust the brightness at the night vision device side is disclosed, but a method of automatically adjusting the brightness by the training simulator system is not disclosed.

Therefore the user must adjust the projection apparatus, the night vision device or the IR image contents manually so as to achieve a desired brightness. The manual adjustment of the brightness of the IR image by the user is complicated and time consuming, which results in an increase in operation costs of the training simulator.

### SUMMARY OF THE INVENTION

The present invention in its first aspect provides a projection apparatus that projects a projection image of invisible light onto a projection plane, the projection apparatus comprising:

a light source configured to emit light including invisible light:

a projecting unit configured to project the projection image by modulating light emitted from the light source based on input image data;

a first acquiring unit configured to acquire first characteristic information indicating a wavelength conversion characteristic of goggles that convert a wavelength of the projection image and output an image of visible light to a user; and

an adjusting unit configured to adjust brightness of the projection image on the projection plane based on the first characteristic information.

The present invention in its second aspect provides a control device that controls a projection apparatus which includes a light source configured to emit light including invisible light, and a projecting unit configured to project a projection image by modulating light emitted from the light source based on input image data, the control device comprising:

a first acquiring unit configured to acquire first characteristic information indicating a wavelength conversion characteristic of goggles that convert a wavelength of the projection image and output an image of visible light to a user; and

a controlling unit configured to control at least one of the light source and the projecting unit, so as to adjust brightness of the projection image on the projection plane based on the first characteristic information.

The present invention in its third aspect provides a control method for a projection apparatus that includes a light source configured to emit light including invisible light components, and projects a projection image of invisible light onto a projection plane, the control method comprising:

a projecting step of projecting the projection image by modulating light emitted from the light source based on input image data;

a first acquiring step of acquiring first characteristic information indicating a wavelength conversion characteristic of goggles that convert a wavelength of the projection image and output an image of visible light to a user; and

an adjusting step of adjusting brightness of the projection image on the projection plane based on the first characteristic information.

The present invention in its fourth aspect provides a control method for a control device that controls a projection apparatus which includes a light source configured to emit light including invisible light, and a projecting unit configured to project a projection image by modulating light emitted from the light source based on input image data, the control method comprising:

a first acquiring step of acquiring first characteristic information indicating a wavelength conversion characteristic of goggles that convert a wavelength of the projection image and output an image of visible light to a user; and

a controlling step of controlling at least one of the light source and the projecting unit, so as to adjust brightness of the projection image on the projection plane based on the first characteristic information.

The present invention in its fifth aspect provides a non-transitory computer readable medium that stores a program, wherein the program causes a computer to execute: a control method for a projection apparatus that includes a light source configured to emit light including invisible light components, and projects a projection image of invisible light onto a projection plane, the control method comprising:

a projecting step of projecting the projection image by modulating light emitted from the light source based on input image data;

a first acquiring step of acquiring first characteristic information indicating a wavelength conversion characteristic of goggles that convert a wavelength of the projection image and output an image of visible light to a user; and

an adjusting step of adjusting brightness of the projection image on the projection plane based on the first characteristic information.

Further features of the present invention will become apparent from the following description of exemplary embodiments with reference to the attached drawings.

### BRIEF DESCRIPTION OF THE DRAWINGS

FIG. 1 is a diagram depicting a training simulator system according to each embodiment;

FIG. 2 is a block diagram depicting a configuration of a projection apparatus according to each embodiment;

FIG. 3 is a block diagram depicting a configuration of night vision goggles according to each embodiment;

FIG. 4 is a flow chart depicting an operation of the night vision goggles according to each embodiment;

FIG. 5A to FIG. 5C show a diagram and tables for explaining the sensitivity characteristic data of the night vision goggles according to each embodiment;

FIG. 6 is a diagram depicting the deterioration of each characteristic according to each embodiment;

FIG. 7A to FIG. 7C are flow charts depicting an operation of the projection apparatus according to First embodiment to Third embodiment;

FIG. 8A to FIG. 8C are flow charts depicting an operation of the projection apparatus according to Fourth embodiment to Sixth embodiment:

FIG. 9A and FIG. 9B are tables for explaining acquisition of the sensitivity characteristic data of the night vision goggles according to each embodiment;

FIG. 10A to FIG. 10K show a diagram and tables for explaining the spectral characteristic data of the light source of the projection apparatus according to Third embodiment; and

FIG. 11A and FIG. 11B show an example of the assumed spectral characteristic data of the contents of the IR image according to Sixth embodiment.

### DESCRIPTION OF THE EMBODIMENTS

Each example will be described in detail with reference to the drawings. Images in this description may be still images or moving images. However an image that is displayed for training is primarily assumed to be a moving image.

### First Embodiment

In First embodiment, a liquid crystal projector will be described as an example of the projection apparatus. The liquid crystal projector may be either a single-plate type or a three-plate type, which are both known types. For the projection apparatus, even a Digital Light Processing (DLP) projector using such a display device as digital mirror device (DMD) can implement a similar effect. The liquid crystal projector of this example controls the light transmittance of the liquid crystal elements in accordance with an image to be displayed, and projects the light from the light source, transmitted through the liquid crystal elements, to the screen, whereby the image is displayed. This liquid crystal projector will be described herein below.

(General Configuration)

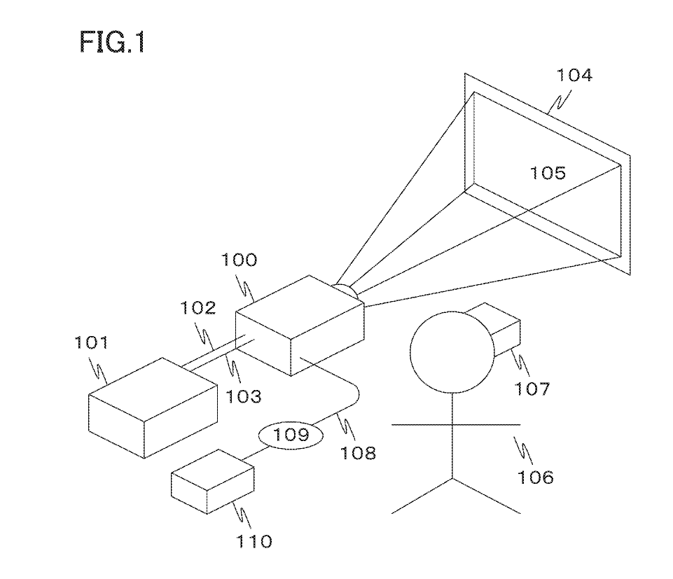

A general configuration of First embodiment will be described first with reference to FIG. 1. FIG. 1 is a perspective view depicting an overview of a system of a training simulator. The system in FIG. 1 includes a liquid crystal projector 100, a personal computer 101, video cables 102 and 103, night vision goggles 107, a network cable 108, a network 109 and a server 110.

The liquid crystal projector 100 receives a signal, which indicates an image of red, green, blue (RGB) color components, from the personal computer 101 (signal source) via a video cable 102. The liquid crystal projector 100 receives a signal, which indicates an image of infrared (IR) components, from the personal computer 101 via the video cable 103. The liquid crystal projector 100 not only displays an input general RGB image on a screen 104 (projection plane) with visible light, but also displays an input IR image in the same manner with infrared light. Thereby a projection image 105, based on the visible light and the infrared light, is displayed on the screen 104. The RGB image displayed with the visible light can be seen with the naked eye, but the IR image displayed with the IR light cannot be seen with the naked eye. The user 106 can indirectly see the IR image using night vision goggles 107, which convert the display image generated by the light containing components of the IR light into an image of visible light. For the video cable 102 to implement this First embodiment, a High-Definition Multimedia Interface (HDMI™) cable, for example, can be used.

The liquid crystal projector 100 can communicate with the server 110, which is connected to the network 109, via the network cable 108. The liquid crystal projector 100 can receive the RGB image and the IR image from the server 110, and display the images on the screen 104. For the network cable 108, an Ethernet™ cable, for example, can be used.

If this system is used, in a training scene assuming that it is daytime, a bright RGB image is displayed, whereby the user 106 can observe the RGB image for the training, without wearing night vision goggles 107. In a training screen assuming that it is nighttime, on the other hand, a black or semi-black RGB image is displayed together with the IR image, whereby the user 106 can observe the IR image for the training in a state of wearing night vision goggles 107.

(Basic Configuration of Liquid Crystal Projector)

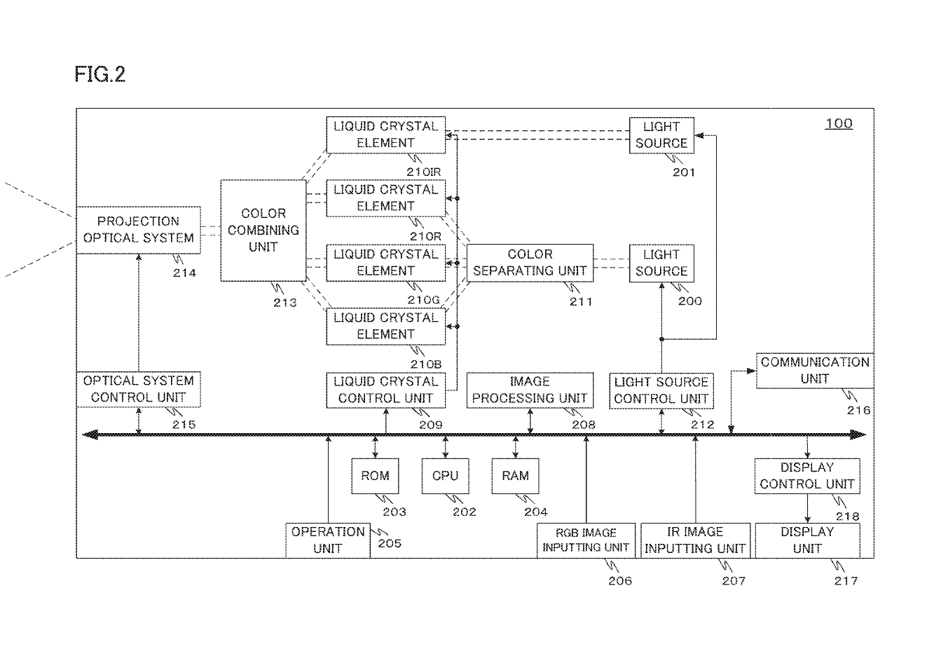

The internal configuration of the liquid crystal projector 100 will be described with reference to FIG. 2. FIG. 2 is a diagram depicting a general configuration of the liquid crystal projector 100) of this First embodiment. The liquid crystal projector 100 of this First embodiment includes a CPU (processor) 202, a ROM 203, a RAM 204, an operation unit 205, an RGB image inputting unit 206, an IR image inputting unit 207, and an image processing unit 208. The liquid crystal projector 100 further includes a liquid crystal control unit 209, liquid crystal elements 210R, 210G, 210B and 2101R, a light source control unit 212, a light source 200 that emits visible light, a light source 201 that emits invisible light, a color separating unit 211, and a color combining unit 213. The liquid crystal projector 100 further includes an optical system control unit 215, a projection optical system 214, and a communication unit 216. The liquid crystal projector 100 may also include a display control unit 217 and a display unit 218.

The CPU 202 controls each operation block of the liquid crystal projector 100. The read only memory (ROM) 203 stores the control program in which the processing procedure of the CPU 202 is written. The random access memory (RAM) 204 temporarily stores the control program and the data as a work memory. Each function of the liquid crystal projector 100 according to this First embodiment is implemented as an operation of the CPU 202. In concrete terms, each function of the liquid crystal projector 100 according to this First embodiment is implemented by the program stored in the ROM 203 that is developed in the RAM 204, and the CPU 202 executing this program.

The operation unit 205 receives an instruction from the user and sends an instruction signal to the CPU 202. For example, the operation unit 205 is constituted by switches and dials, a touch panel disposed on the display unit 218 and the like. The operation unit 205 may be, for example, a signal receiving unit (not illustrated) which receives a signal from a remote controller, and sends a predetermined instruction signal to the CPU 202 based on the received signal. The CPU 202 also receives a control signal which is input from the operation unit 205 or the communication unit 216, and controls each operation block of the liquid crystal projector 100.

The RGB image inputting unit 206 is an image inputting unit for displaying visible light constituted by red (R), green (G) and blue (B). The RGB image inputting unit 206 receives visible light image data (input image data) from an external device, such as a personal computer 101. The RGB image inputting unit 206 includes, for example, a composite terminal, an S image terminal, a D terminal, a component terminal, an analog RGB terminal, a DVI-I terminal, a DVI-D terminal, an HDMI™ terminal, and a Display Port™ terminal. If analog image data is received, the RGB image inputting unit 206 converts the received analog image data into digital image data. Then the RGB image inputting unit 206 sends the received image data to the image processing unit 208. Here the external device may be a device other than the personal computer 101, such as a camera, a portable telephone, a smartphone, a hard disk recorder, and a game machine, as long as the image data can be output.

The IR image inputting unit 207 is an image inputting unit for displaying invisible light represented by an infrared (IR) light, and receives invisible light image data (input image data) from an external device, such as a personal computer 101. The IR image inputting unit 207 includes, for example, a composite terminal, an S image terminal, a D terminal, a component terminal, an analog RGB terminal, a DVI-I terminal, a DVI-D terminal, an HDMI™ terminal, and a Display Port™ terminal. If analog image data is received, the IR image inputting unit 207 converts the received analog image data into digital image data. Then the IR image inputting unit 207 sends the received image data to the image processing unit 208. Here the external device may be a device other than the personal computer 101, such as a camera, a portable telephone, a smartphone, a hard disk recorder, and a game machine, as long as the image data can be output.

The image processing unit 208 performs processing to change the number of frames, the number of pixels, an image profile or the like on the image data received from the RGB image inputting unit 206 or the IR image inputting unit 207, and transmits the image data to the liquid crystal control unit 209 after the change. The image processing unit 208 is configured by, for example, a microprocessor for image processing or an application specific integrated circuit (ASIC) constituted by logic circuits. The image processing unit 208 may be configured by a field-programmable gate array (FPGA). The image processing unit 208 need not be a dedicated microprocessor. ASIC or FPGA, but may be implemented, for example, by the CPU 202 executing the same processing as the image processing unit 208 using a program stored in the ROM 203. The image processing unit 208 can execute such functions as frame skipping processing, frame interpolating processing, resolution converting processing, image combining processing, geometric correcting processing (keystone correcting processing, curved surface correction), and panel correction. Further, the image processing unit 208 may perform the above mentioned change processing for data other than the image data received from the RGB image inputting unit 206 and the IR image inputting unit 207, as well, such as a still image and moving image regenerated by the CPU 202.

The liquid crystal control unit 209 adjusts the transmittance of the liquid crystal elements 210R, 210G, 210B and 2101R by controlling the voltage that is applied to the liquid crystals of the pixels of the liquid crystal elements 210R, 210G, 210B and 210IR, based on the image data processed by the image processing unit 208. The liquid crystal control unit 209 is configured by an ASIC, an FPGA or the like constituted by logic circuits for control. The liquid crystal control unit 209 need not be a dedicated ASIC, but may be implemented, for example, by the CPU 202 executing the same processing as the liquid crystal control unit 209 using a program stored in the ROM 203. For example, if the image data is input to the image processing unit 208, the liquid crystal control unit 209 controls the liquid crystal elements 210R, 210G, 210B and 210IR each time one frame of an image is received from the image processing unit 208, so as to be a transmittance corresponding to the image.

The liquid crystal element 210R is a liquid crystal element corresponding to red, and adjusts the transmittance of the red light out of the light which was output from the light source 200, and separated into red (R), green (G) and blue (B) by the color separating unit 211. In other words, the liquid crystal element 210R modulates the red light. The liquid crystal element 210G is a liquid crystal element corresponding to green, and adjusts the transmittance of the green light out of the light which was output from the light source 200, and separated into red (R), green (G) and blue (B) by the color separating unit 211. In other words, the liquid crystal element 210G modulates the green light. The liquid crystal element 210B is a liquid crystal element corresponding to blue, and adjusts the transmittance of the blue light out of light which was output from the light source 200, and separated into red (R), green (G) and blue (B) by the color separating unit 211. In other words, the liquid crystal element 210B modulates the blue light. The liquid crystal element 210IR is a liquid crystal element corresponding to the infrared light (IR), and adjusts the transmittance of the infrared light (IR) output from the light source 201. In other words, the liquid crystal element 2101R modulates the infrared light.

The light source control unit 212 controls the ON/OFF of the light source 200 and the light source 201, and controls the quantity of light. The light source control unit 212 is configured by an ASIC or an FPGA constituted by logic circuits for control. The light source control unit 212 need not be a dedicated ASIC, and may be implemented, for example, by the CPU 202 executing the same processing as the light source control unit 212 using a program stored in the ROM 203.

The light source 200 and the light source 201 output the visible light and the invisible light to project an image on the screen 104. The light source 200 and the light source 201 are, for example, halogen lamps, xenon lamps, high pressure mercury lamps, LED light sources or laser diodes. Further, the light source 200 and the light source 201 may be light sources that convert the light wavelength by exciting the light emitted from the laser diode by phosphor or the like. The light source 201 may partially include visible light components in the emitted light, and the light source 200 may partially include invisible light components in the emitted light. For example, it is assumed that the light source 200 primarily emits visible light, and the light source 201 primarily emits invisible light. Here “primarily emits visible light” is a case when the wavelength of the main peak in the spectral characteristic of the light source is in the visible light region, for example. “Primarily emits invisible light” is a case when the wavelength of the main peak in the spectral characteristic of the light source is in the invisible light region, for example. The color separating unit 211 separates the light output from the light source 200 into red (R), green (G) and blue (B), and is constituted by a dichroic mirror, a prims and the like, for example. If LEDs corresponding to each color are used as the light source 200, the color separating unit 211 is not necessary.

The color combining unit 213 combines the red light (R), green light (G) and blue light (B) and the infrared light (IR) transmitted through the liquid crystal elements 210R. 210G. 210B and 210IR, and is constituted by a dichroic mirror, a prism and the like, for example. The light generated by combining the components of red (R), green (G) and blue (B) and infrared light (IR) by the color combining unit 213 is sent to the projection optical system 214. At this time, each transmittance of the liquid crystal elements 210R. 210G, 210B and 2101R is controlled by the liquid crystal control unit 209, so that the light which transmitted through each liquid crystal element becomes a light corresponding to the image input by the image processing unit 208. The light combined by the color combining unit 213 is projected onto the screen 104 by the projection optical system 214, whereby the visible light image and the invisible light image corresponding to the image input by the image processing unit 208 are displayed on the screen 104. If the later mentioned night vision goggles 107 are used when the invisible image generated by the infrared light is displayed on the screen 104, the displayed image can be seen.

The optical system control unit 215 controls the projection optical system 214, and is configured by a microprocessor for control. The optical system control unit 215 need not be a dedicated microprocessor, but may be implemented, for example, by the CPU 202 executing the same processing as the optical system control unit 215 using a program stored in the ROM 203. The optical system control unit 215 may also be implemented by an ASIC, an FPGA or the like, which is configured by a dedicated logic circuit. Further, the projection optical system 214 projects the combined light output from the color combining unit 213 onto the screen. The projection optical system 214 is constituted by a plurality of lenses and an actuator for driving the lenses, and can perform zoom in, zoom out of the projected image, focus adjustment, lens shift and the like by driving the lenses by an actuator.

The communication unit 216 receives a control signal, still image data, moving image data and the like from an external device. The communication system is not especially limited, and may be, for example, wireless local area network (LAN), cable LAN, Universal Serial Bus (USB), or Bluetooth™. If the terminal of the RGB image inputting unit 206 is an HDMI™ terminal, for example, then Consumer Electronics Control (CEC) communication may be performed via this terminal. The external device here may be any device that can communicate with the liquid crystal projector 100, such as a personal computer, a camera, a portable telephone, a smartphone, a hard disk recorder, a game machine, a flash memory and a remote controller. For example, the communication unit 216 acquires device information, such as a conversion characteristic (including a wavelength conversion characteristic) from the later mentioned night vision goggles 107. The CPU 202 receives the RGB image and the IR image from an external device that can communicate via the communication unit 216, and sends these images to the image processing unit 208, whereby these images can be projected and displayed.

The display control unit 217 performs control to display the operation screen and such images as switch icons, to operate the liquid crystal projector 100, on the display unit 218 provided in the liquid crystal projector 100, the display control unit 217 being configured by, for example, a microprocessor for performing display control. The display control unit 217 need not be a dedicated microprocessor, but may be implemented, for example, by the CPU 202 executing the same processing as the display control unit 217 using a program stored in the ROM 203.

The display unit 218 displays an operation screen and switch icons, to operate the liquid crystal projector 100. The display unit 218 may be any device that can display images. For example, the display unit 218 may be a liquid crystal display, a CRT display, an organic EL display, an LED display, a standalone LED, or a combination thereof.

The image processing unit 208, the liquid crystal control unit 209, the light source control unit 212, the optical system control unit 215 and the display control unit 217 of this First embodiment may be an ASIC or the like, which is configured by a standalone or a plurality of microprocessors and logic circuits which can perform similar processing as each of these functional blocks. Each of these blocks may also be implemented, for example, by the CPU 202 executing the same processing as each block using a program stored in the ROM 203.

(Basic Configuration of Night Vision Goggles)

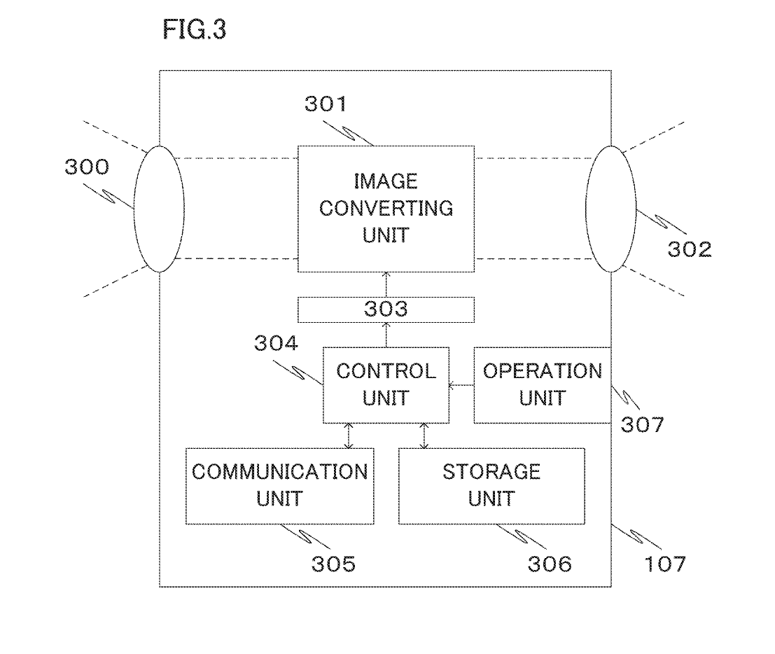

The internal configuration of the night vision goggles 107 will be described with reference to FIG. 3. The night vision goggles 107 include object lenses 300, an image converting unit 301, eyepieces 302, a power supply unit 303, a control unit 304, a communication unit 305, a storage unit 306, and an operation unit 307.

The objective lens 300 allows the light reflected by the screen 104 to enter the image converting unit 301. The image converting unit 301 is configured by a photomultiplier tube, and amplifies the intensity of the incident light, converts the infrared light into visible light, and outputs the visible light to the eyepiece 302. To be more specific, the image converting unit 301 converts the wavelength of the incident light, including the infrared light, into a wavelength in the visible region. Further, the image converting unit 301 may include an optical system using a prism and an optical fiber that inverts an image formed by the photo-multiplier tube, so that the image observed via the eyepieces 302 becomes an erect image. The eyepieces 302 are lenses disposed on the side of the user. The user of the night vision goggles 107 can observe the visible image formed by the image converting unit 301 via the eyepieces 302.

The power supply unit 303 is a circuit that supplies power to the image converting unit 301, and is controlled by the control unit 304. The control unit 304 is configured by a microcomputer, and controls each unit of the night vision goggles 107. The communication unit 305 is an interface to communicate with an external device wirelessly or via a cable. The communication unit 305 can be configured using a transmission/reception circuit corresponding to such a communication system as Ethemet™, wireless LAN and Bluetooth™. Other communication systems are also applicable to this First embodiment. The control unit 304 can communicate with an external device via the communication unit 305. The storage unit 306 is a non-volatile memory, and stores or reads the data responding to an instruction by the control unit 304. The operation unit 307 is configured by such members as buttons. The control unit 304 can receive instructions from the user to start and end the operation via the operation unit 307.

(Operation Flow of Night Vision Goggles)

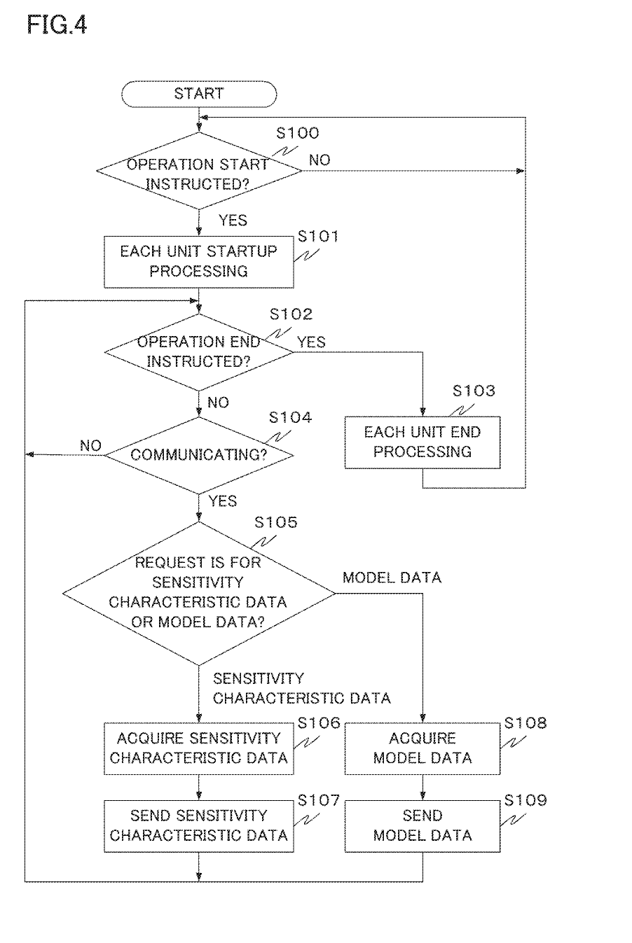

An operation flow of the night vision goggles 107 will be described with reference to FIG. 4. The flow chart in FIG. 4 is started, for example, when power is supplied to the power supply unit 303. In step S100, the control unit 304 confirms whether the user instructed to start operation of the night vision goggles 107 via the operation unit 307. If no instruction to start the operation is received (step S100: NO), the processing in step S100) is repeated. If the instruction to start the operation is received (step S100: YES), processing advances to step S101.

In step S101, after the instruction to start operation is received from the operation unit 307, the control unit 304 sends an instruction so that the communication unit 305 and the storage unit 306 can operate, and instructs the power supply unit 303 to start supplying power to the image converting unit 301. Then in step S102, the control unit 304 confirms whether the user instructed to end the operation via the operation unit 307. If no instruction to end the operation is received (step S102: NO), processing advances to step S104. If the instruction to end the operation is received (step S102: YES), processing advances to step S103. In step S103, the control unit 304 instructs the communication unit 305 and the storage unit 306 to shut down, and instructs the power supply unit 303 to stop supplying power to the image converting unit 301. Then the processing returns to step S100.

In step S104, the control unit 304 confirms whether there is communication from an external device via the communication unit 305. If there is communication from an external device (step S104: YES), processing advances to step S105. If there is no communication from the external device (step S104: NO), processing returns to step S102.

In step S105, the control unit 304 confirms whether the information requested by the communication from the external device is sensitivity characteristic data or model data. If the requested data is sensitivity characteristic data, processing advances to step S106. If the requested data is model data, processing advances to step S108. Note that, as described later, sensitivity characteristic data is characteristic information indicating a conversion characteristic of the wavelength conversion of the night vision goggles.

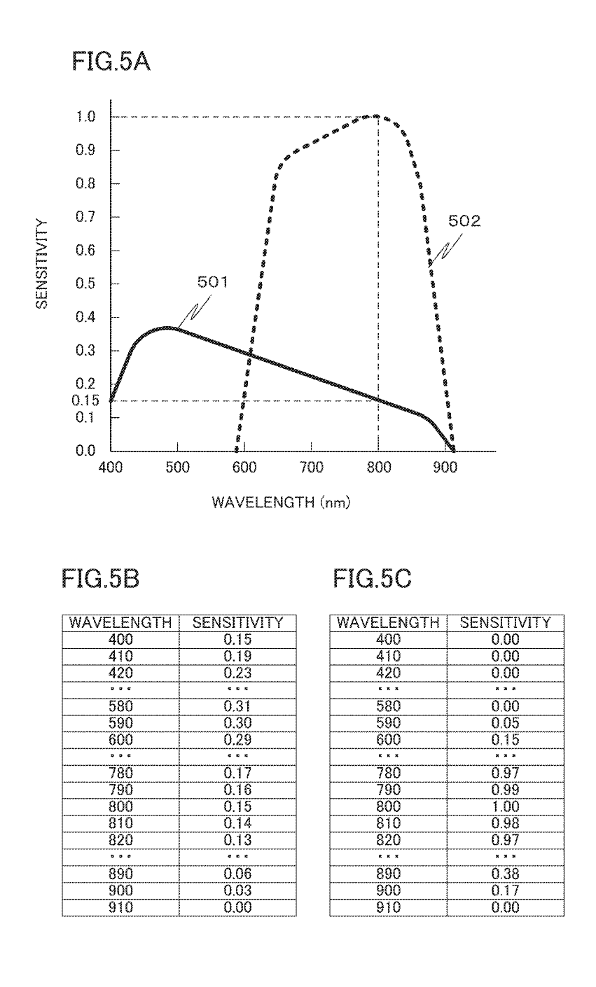

In step S106, the control unit 304 reads the sensitivity characteristic data from the storage unit 306. Now the sensitivity characteristic data will be described with reference to FIG. 5A to FIG. 5C. FIG. 5A is a graph depicting the sensitivity characteristic of the night vision goggle. The ordinate indicates the sensitivity of the night vision goggles, and the abscissa indicates the wavelength of the light that enters the night vision goggles. For example, the sensitivity here may be determined as sensitivity 1.0 when light, which has predetermined energy A at a wavelength indicated in the abscissa, enters the night vision goggles 107, is then converted into visible light having another wavelength by the image converting unit 301, and the energy of this visible light is B. In other words, the sensitivity characteristic data is the efficiency to convert the invisible light into visible light (conversion efficiency), or ratio or gain. The higher the sensitivity characteristic data value the higher the efficiency to convert the invisible light into visible light. In this case, it is assumed that A and B are predetermined. Other definitions of sensitivity are also applicable to this First embodiment. Other definitions can be used for the sensitivity characteristic data, as long as these values indicate the relationship between the intensity of the light that enters the night vision goggles and the brightness of the light that is observed when this light is seen via the night vision goggles. The solid line 501 and the dotted line 502 in FIG. 5A were generated by plotting the sensitivity characteristics of two different types of night vision goggles 107 as an example.

For the sensitivity characteristic data, the sensitivity of a typical wavelength of the liquid crystal projector 100, which projects the infrared light, for example, can be used. In the case of an 800 nm wavelength, for example, the sensitivity characteristic data, in the case of the night vision goggles corresponding to the solid line 501, is 0.15, and the sensitivity characteristic, in the case when the night vision goggles corresponding to the dotted line 502, is 1.0.

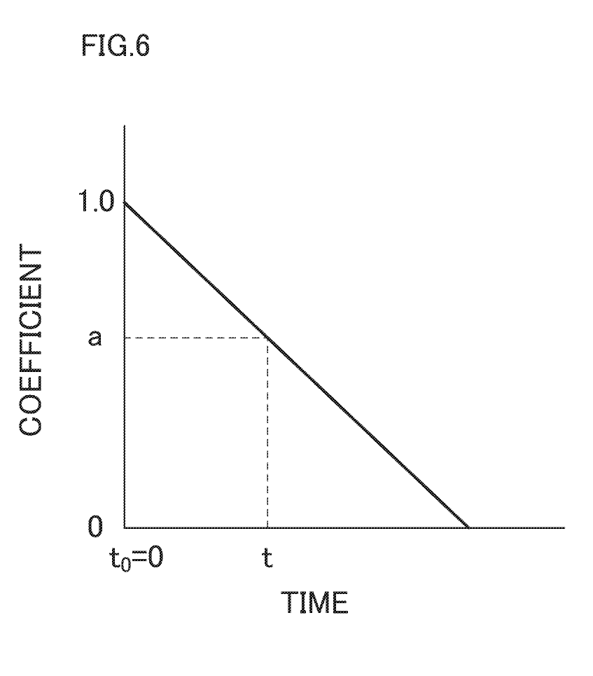

An example of reading fixed sensitivity characteristic data from the storage unit 306 was described, but this First embodiment is not limited to this method. For example, in step S106, the control unit 304 measures the operation time of the image converting unit 301, stores this operation time in the storage unit 306, and the sensitivity characteristic data is corrected using an aging deterioration coefficient acquired based on the operation time. This example will be described with reference to FIG. 6. In FIG. 6, the abscissa indicates the operation time of the image converting unit 301, and the ordinate indicates the coefficient with respect to the sensitivity. The image converting unit 301 deteriorates due to aging, hence the coefficient with respect to the sensitivity monotonically decreases. By storing this relationship in the storage unit 306 in advance, the control unit 304 can determine the coefficient a from the operation time t of the image converting unit 301. The sensitivity characteristic data, considering the aging deterioration, can be acquired by multiplying the above mentioned sensitivity characteristic data by this coefficient a. When this is applied to the above example, if a=0.6, the sensitivity characteristic data in the case of the night vision goggles corresponding to the solid line becomes 0.15×0.6=0.09, and the sensitivity characteristic data in the case of the night vision goggles corresponding to the dotted line becomes 1.00×0.6=0.60. The deterioration characteristic is not limited to the example in FIG. 6, but may be a different characteristic. For example, even a characteristic which deteriorates non-linearly can be applied to this First embodiment in the same manner if this characteristic is stored in the storage unit 306.

Further, a spectral sensor, which measures light that enters the image converting unit 301, and a spectral sensor, which measures light that emits from the image converting unit 301, may be provided, so that the sensitivity characteristic data is determined based on the correspondence of the output values of these sensors. Instead of the spectral sensors, a sensor that measures the intensity of the light having a specific wavelength may be used. In this case, the sensitivity characteristic data that indicates the sensitivity at this specific wavelength can be acquired.

Then in step S107, the control unit 304 transmits the sensitivity characteristic data acquired in step S106 to the external device. Then processing returns to step S102.

In step S108, on the other hand, the control unit 304 reads the model data from the storage unit 306. The model data includes individual information for specifying individual night vision goggles 107, and type information for specifying a model number. In concrete terms, type information is a model number of the night vision goggles 107 or the like. The individual information is an individual identification number of the night vision goggles 107, or data on the type of the photo-multiplier tube of the image converting unit 301. In other words, any data of which value corresponds to a predetermined sensitivity characteristic data can be used as the model data. Then in step S109, the control unit 304 sends the model data acquired in step S108 to the external device. Then processing returns to step S102.

An example of the night vision goggles 107 calculating the deterioration was described, but an external device may calculate the deterioration. In this case, the external device stores the relationship between the operation time and deterioration in advance, and the night vision goggles 107 send the sensitivity characteristic data and the operation time of the image converting unit 301 to the external device, whereby the same calculation can be performed on the external device side.

(Basic Operation Flow of Liquid Crystal Projector)

The operation flow of the liquid crystal projector 100 will be described next. When the power is supplied to the liquid crystal projector 100 via a power cable (not illustrated), power is supplied to the CPU 202, the ROM 203, the RAM 204, the operation unit 205, and the communication unit 216, and the CPU 202 starts up and enters the standby state. When the CPU 202 detects a projection start instruction here via the operation unit 205 or the communication unit 216, the CPU 202 performs the processing to start each unit of the liquid crystal projector 100. In concrete terms, the CPU 202 performs control to supply power to each unit, and sets each unit so as to be operable. Further, the CPU 202 sends an instruction to the light source control unit 212 to turn the light source 200 ON. The CPU 202 also activates the cooling fan (not illustrated). Thereby the liquid crystal projector 100 starts projection, and the CPU 202 enters the display state. If the CPU 202 detects an image quality adjustment instruction for the display image here from the user via the operation unit 205, the CPU 202 may instruct the image processing unit 208 to perform image processing for this image quality adjustment. If the CPU 202 detects the projection end instruction here from the user via the operation unit 205, the CPU 202 instructs the light source control unit 212 to turn the light source 200 OFF, and shuts down the power supply of each unit of the liquid crystal projector 100. Thereby the CPU 202 returns to the standby state.

(Characteristic Operation Flow of Liquid Crystal Projector)

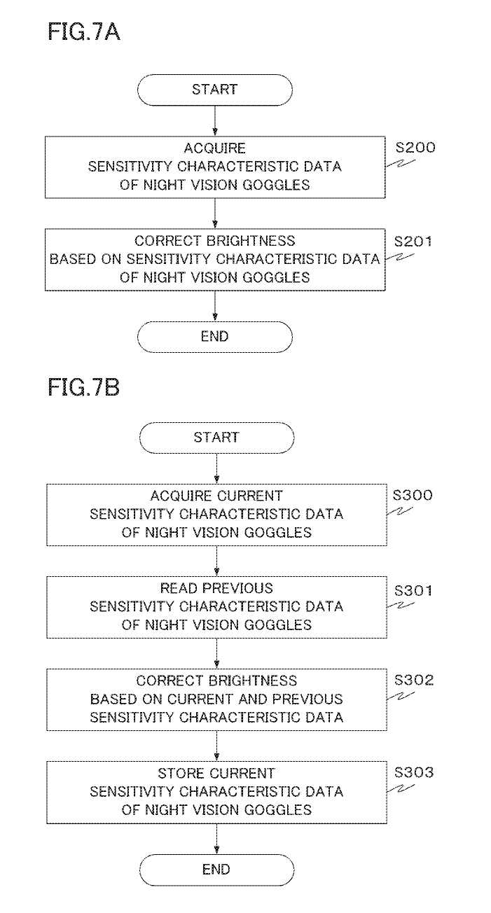

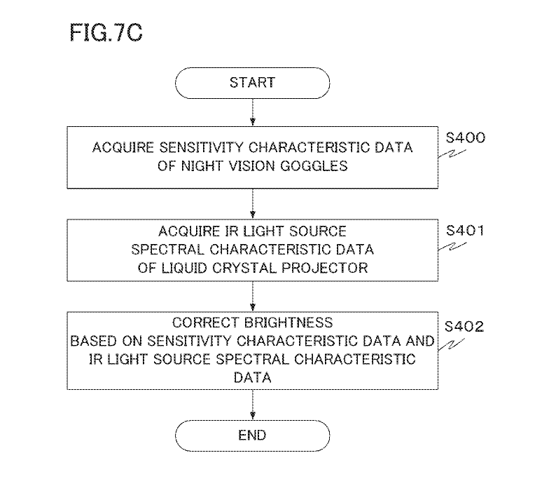

The characteristic operation flow of the liquid crystal projector 100 will be described next with reference to FIG. 7A. An administrator of the training simulator system can instruct the liquid crystal projector 100 to adjust the brightness of the IR image via the operation unit 205 and the communication unit 216. The brightness of the IR image can be regarded as the brightness of the IR image projected onto the screen 104. When an instruction to adjust the brightness of the IR image is received in the display state, the CPU 202 of the liquid crystal projector 100 starts the flow in FIG. 7A. A trigger to start the flow in FIG. 7A, however, is not limited to this example. For example, the flow in FIG. 7A may be started at a timing when the standby state changes to the display state, a timing when the display state changes to the standby state, or a timing when the power is supplied to the liquid crystal projector 100.

In step S200, the CPU 202 requests the night vision goggles 107, via the communication unit 216, to send the sensitivity characteristic data. As mentioned above, the control unit 304 of the night vision goggles 107 detects this request in step S104 in FIG. 4, and sends the sensitivity characteristic data to the liquid crystal projector 100 via the communication unit 305 in step S107. The CPU 202 receives, via the communication unit 216, the sensitivity characteristic data sent from the night vision goggles 107.

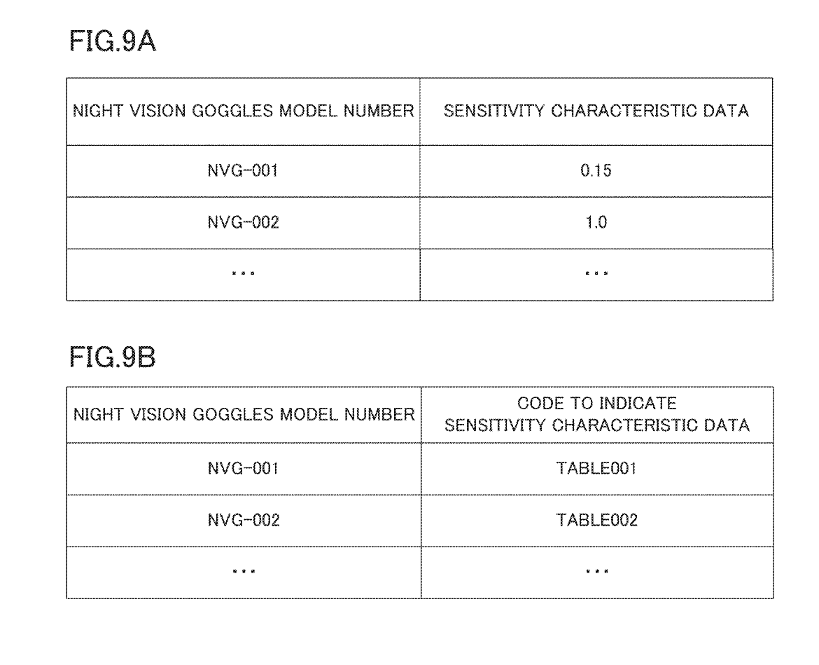

A different method of acquiring the sensitivity characteristic data may be applied to this First embodiment. For example, the user may input the sensitivity characteristic data using the operation unit 205. Or the CPU 202 may request the night vision goggles 107 to send the model data via the communication unit 216. In this case, as mentioned above, the control unit 304 of the night vision goggles 107 detects this request in step S104 in FIG. 4, and sends the model data to the liquid crystal projector 100 via the communication unit 305 in step S109. The CPU 202 receives the model data sent from the night vision goggles 107 via the communication unit 216. At this time, the correspondence table between the model data and the sensitivity characteristic data is stored in the ROM 203 in advance, whereby the CPU 202 acquires the sensitivity characteristic data of the night vision goggles 107 based on the acquired model data. FIG. 9A shows the example of this table. The table in FIG. 9A is an example when the model number of the night vision goggles 107 is used as the model data. This table stores the sensitivity with respect to a typical wavelength (e.g. 800 nm) of the light for the night vision goggles corresponding to certain model data. For example, if the model number, which is the model data received from the night vision goggles 107, is NVG-001, 0.15 is acquired as the sensitivity characteristic data, and if the model number is NVG-002, 1.0 is acquired as the sensitivity characteristic data. The model data is not limited to the model number, but may be any data which can be corresponded with the sensitivity characteristic data, such as an individual identification number of the night vision goggles 107, or the type of the photomultiplier tube of the image converting unit 301. The model data may be acquired by a method other than being received from the night vision goggles 107. For example, the model data may be input by the user using the operation unit 205.

Then in step S201, the CPU 202 corrects the brightness of the IR image based on the sensitivity characteristic data of the night vision goggles 107 acquired in step S200. This correction method will be described next. The ROM 203 holds in advance a target value that is used for determining whether the acquired sensitivity characteristic data is lower or higher than a target brightness. For this target value, a target value of the sensitivity of the night vision goggles 107 is used. In this step, when the acquired sensitivity characteristic data is lower than the target brightness, the CPU 202 instructs the light source control unit 212 to increase the quantity of light of the light source 201. Further, when the acquired sensitivity characteristic data is higher than the target brightness, the CPU 202 instructs the light source 201 to decrease the quantity of light. In concrete terms, if the target value is 0.20 and the acquired sensitivity characteristic data is 0.15, for example, the CPU 202 instructs the light source control unit 212 so that the quantity of light of the light source 201 becomes 0.20/0.15=133%. If the target value is 0.80 and the acquired sensitivity characteristic data is 1.00, for example, the CPU 202 instructs the light source control unit 212 so that the quantity of light of the light source 201 becomes 0.80/1.00=80%.

To set the target value, methods other than the method of storing the target values in the ROM 203 in advance may be used. For example, a user, such as an administrator of the training simulator, may input the target value via the operation unit 205, and the CPU 202 may receive this value. To correct the brightness, methods other than the method to increase/decrease the quantity of the IR light irradiated from the liquid crystal projector 100) may be used. For example, the CPU 202 may instruct the image processing unit 208 to increase/decrease the gradation of the IR image. Or the CPU 202 may instruct the liquid crystal control unit 209 to increase/decrease the drive voltage of the liquid crystal element 2101R. Or members (not illustrated) to control the quantity of light such as diaphragm may be disposed on the optical path of the IR light, so that the CPU 202 controls these members to increase/decrease the quantity of light. Or the CPU 202 may instruct the night vision goggles 107, via the communication unit 216, to change the gain to convert the IR light into the visible light. In this way, any means may be used as long as the brightness of the displayed IR image, observed via the night vision goggles 107, can be adjusted. After the processing in step S201, this flow ends.

According to this First embodiment, the liquid crystal projector 100 can control the quantity and brightness of the IR light, so as to minimize the change of brightness of the view of the image via the night vision goggles, even if the devices deteriorate or are replaced during the training simulation. Therefore the administrator who maintains the training simulation system can adjust brightness more easily.

### Second Embodiment

This is an example when the liquid crystal projector in First embodiment is modified. The differences from First embodiment will be mainly explained herein below, omitting description on common portions with First embodiment.

(Characteristic Operation Flow of Liquid Crystal Projector)

FIG. 7B is a modification of the operation flow of the CPU 202 of the liquid crystal projector 100. The start condition of this flow is the same as FIG. 7A of First embodiment. Step S300 is the same as step S200. In step S301, the CPU 202 reads the previous sensitivity characteristic data of the night vision goggles from the ROM 203. The previous sensitivity characteristic data is stored in the later mentioned step S303, and is a sensitivity characteristic data of the night vision goggles 107 when this flow was executed the last time. In this case, when this flow is executed for the first time, the previous sensitivity characteristic data cannot be acquired, hence the target value described in step S201 in FIG. 7A of First embodiment, for example, is used.

Then in step S302, the CPU 202 corrects the brightness of the IR image based on the current sensitivity characteristic data of the night vision goggles 107 acquired in step S300, and the previous sensitivity characteristic data of the night vision goggles 107 acquired in step S301. This correction method will be described next. In step S302, if the current sensitivity characteristic data is lower than the previous sensitivity characteristic data, the CPU 202 instructs the light source control unit 212 to increase the quantity of light of the light source 201. If the acquired sensitivity characteristic data is higher than the target brightness, the CPU 202 instructs the light source 201 to decrease the quantity of light. In concrete terms, if the previous sensitivity characteristic data is 0.15 and the current sensitivity characteristic data is 0.09, for example, the CPU 202 instructs the light source control unit 212 to adjust the quantity of light of the light source 201 to 0.15/0.09=167%. Note that the sensitivity characteristic data indicates the sensitivity with respect to the typical wavelength (e.g. 80) nm) of the night vision goggles 107.

To correct the brightness, methods other than the method of increasing/decreasing the quantity of the IR light irradiated from the liquid crystal projector 100 may be used. For example, the CPU 202 may instruct the image processing unit 208 to increase/decrease the gradation of the IR image. Or the CPU 202 may instruct the liquid crystal control unit 209 to increase/decrease the drive voltage of the liquid crystal element 2101R. Or members (not illustrated) to control the quantity of light such as diaphragm may be disposed on the optical path of the IR light, so that the CPU 202 controls these members to increase/decrease the quantity of light. Or the CPU 202 may instruct the night vision goggles 107, via the communication unit 216, to change the gain to convert the IR light into visible light. In this way, any means may be used, as long as the brightness of the displayed IR image, observed via the night vision goggles 107, can be adjusted.

Then in step S303, the CPU 202 stores the current sensitivity characteristic data of the night vision goggles 107 acquired in step S300 in the ROM 203. This sensitivity characteristic data is read by the CPU 202 as the previous sensitivity characteristic data when this flow in FIG. 7B is executed the next time in step S301. After step S303, this flow ends.

In Second embodiment, the quantity of light of the IR image projected by the liquid crystal projector 100 is adjusted based on the current sensitivity characteristic data and the previous sensitivity characteristic data. Thereby the user who sees the corrected IR image wearing the night vision goggles 107 can adjust the view of the image seen via the night vision goggles 107 to the view of the image when the sensitivity characteristic was previously acquired wearing the night vision goggles 107. In Second embodiment, it is assumed that the current sensitivity characteristic data and the previous sensitivity characteristic data are acquired using the same night vision goggles 107, but different night vision goggles may be used. In this case, the view of the image via night vision goggles worn by the user can be matched with the view of the image seen via any different night vision goggles.

According to Second embodiment, the liquid crystal projector 100 can control the quantity and brightness of the IR light, so as to minimize the change of the brightness of the view of the image via the night vision goggles, even if the devices deteriorate or are replaced during the training simulation. Therefore the administrator who maintains the training simulation system can adjust brightness more easily.

### Third Embodiment

This is another example when the liquid crystal projector in First embodiment is modified. Differences from First embodiment will be mainly explained herein below, omitting description on common portions with First embodiment.

(Operation Flow of Night Vision Goggles)

The operation flow of the night vision goggles 107 is modified as follows. This modified operation flow will be described with reference to FIG. 4. In step S105, the control unit 304 reads the sensitivity characteristic data from the storage unit 306, and the sensitivity characteristic data that is read here is modified as follows.

For the sensitivity characteristic data, a numeric value of the sensitivity is taken at every 10 nm wavelength in the plots of the solid line and the dotted line in FIG. 5A, for example. FIG. 5B is an example of the sensitivity characteristic data of the night vision goggles corresponding to the plot of the solid line 501 in FIG. 5A, and FIG. 5C is an example of the sensitivity characteristic data of the night vision goggles corresponding to the plot of the dotted line 502 in FIG. 5A. This data is stored in the storage unit 306 in advance. In Third embodiment, it is assumed that the sensitivity data at each 10 nm wavelength is used as the sensitivity characteristic data, but Third embodiment is not limited to this. The sensitivity values at different intervals may be used, or only the sensitivity value at a representative wavelength may be used. Instead of the sensitivity values, the characteristic of the sensitivity may be fitted by a predetermined function, and the parameter of this function may be used for the sensitivity characteristic data. In other words, any data may be used as long as the sensitivity can be acquired in accordance with the wavelength.

A different method of acquiring the sensitivity characteristic data may be applied to Third embodiment. For example, the user may input the sensitivity characteristic data using the operation unit 205. Or the CPU 202 may request the night vision goggles 107 to send the model data via the communication unit 216. In this case, as mentioned above, the control unit 304 of the night vision goggles 107 detects this request in step S104 in FIG. 4, and the CPU 202 sends the model data to the liquid crystal projector 100 via the communication unit 305 in step S109. The CPU 202 receives the model data sent from the night vision goggles 107 via the communication unit 216. At this time, the correspondence table between the model data and the sensitivity characteristic data is stored in the ROM 203 in advance, whereby the CPU 202 acquires a code to indicate the sensitivity characteristic data of the night vision goggles 107 based on the acquired model data.

FIG. 9B is an example of this table. The table in FIG. 9B is an example when the model number of the night vision goggles 107 is used as the model data. For example, if the model number, which is the model data received from the night vision goggles 107, is NVG-001, TABLE001 is acquired as a code to indicate the sensitivity characteristic data. By storing the sensitivity characteristic data (e.g. FIG. 5B. FIG. 5C) corresponding to each code in the ROM 203 in advance, the CPU 202 can read the sensitivity characteristic data from the ROM 203 using this code. The model data is not limited to the model number, but may be any data which can be corresponded with the sensitivity characteristic data, such as an individual identification number of the night vision goggles 107, or the type of the photomultiplier tube of the image converting unit 301. The model data may be acquired by a method other than the method of being received from the night vision goggles 107. For example, the model data may be input by the user using the operation unit 205.

In the above description, fixed sensitivity characteristic data is read from the storage unit 306, but Third embodiment is not limited to this method. For example, the control unit 304 may measure the operation time of the image converting unit 301, and store this operation time in the storage unit 306, so as to use the sensitivity characteristic data which is corrected by an aging deterioration coefficient acquired based on this operation time. This example will be described with reference to FIG. 6. In FIG. 6, the abscissa indicates the operation time of the image converting unit 301, and the ordinate indicates the coefficient with respect to the sensitivity. The image converting unit 301 deteriorates due to aging, hence the coefficient with respect to the sensitivity monotonically decreases. By storing this relationship in the storage unit 306 in advance, the control unit 304 can determine the coefficient a from the operation time t of the image converting unit 301. By multiplying the above mentioned sensitivity characteristic data by this coefficient a, the sensitivity characteristic data considering the aging deterioration can be acquired. In the case of FIG. 5B and FIG. 5C, if a=0.6, the sensitivity characteristic data is generated by multiplying the numeric values in the column of the sensitivity by 0.6 respectively. Further, a spectral sensor, to measure the light that enters the image converting unit 301, and a spectral sensor, to measure the light that is emitted from the image converting unit 301, may be provided, so as to determine the sensitivity characteristic data using the correspondence of the output values of these sensors.

(Characteristic Operation Flow of Liquid Crystal Projector)

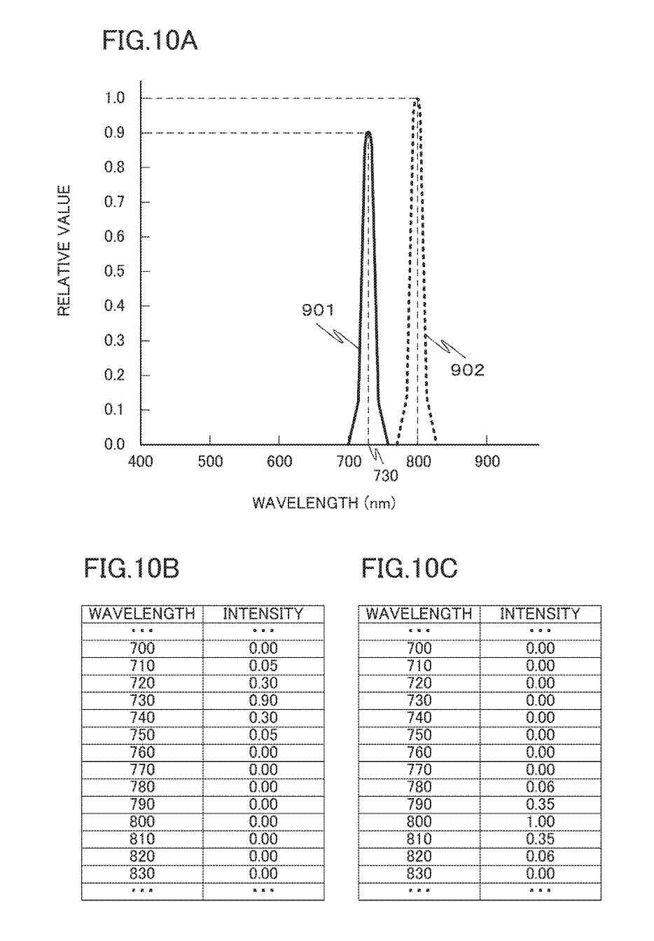

FIG. 7C is a modification of the operation flow of the CPU 202 of the liquid crystal projector 100. The start condition of this flow is the same as FIG. 7A of First embodiment. Step S400 is the same as step S200. In step S401, the CPU 202 reads the spectral characteristic data of the light source 201 from the ROM 203. The spectral characteristic data is spectral information indicating the spectral characteristic of the light source. The spectral characteristic data will be described with reference to FIG. 10A and FIG. 10B.

FIG. 10A is a graph depicting the spectral characteristic of the light source 201 which emits the invisible light. The abscissa indicates the wavelength, and the ordinate indicates the normalized intensity of the light emitted by the light source 201 at this wavelength. In FIG. 10A, the solid line 901 and the dotted line 902 are generated by plotting examples of the spectral characteristics of the two different types of light sources which emit the invisible light.

As an example of the spectral characteristic data, a value of the wavelength at which the intensity is peak, and a value of this intensity, can be used. For example, in the case of the light source having the characteristic indicated by the solid line 901 in FIG. 10A, the wavelength is 730 nm and the intensity is 0.90. In the case of the light source having the characteristic of the dotted line 902 in FIG. 10A, the wavelength is 800 nm and the intensity is 1.0. It is preferable to use this type of spectral characteristic data when the light source, of which spectrum is narrow, such as a laser light source, is used. Another modified type of spectral characteristic data may be used, and for example, only the peak wavelength may be used for the spectral characteristic data. In this case, the intensity corresponding to this wavelength is regarded as a predetermined value, such as 1.00, and subsequent processing is performed, whereby this spectral characteristic data can be applied to Third embodiment. For example, a value of a 730 (nm) wavelength can be used for the spectral characteristic data corresponding to the solid line 901.

Data other than the above mentioned data may be used for the spectral characteristic data. FIG. 10B and FIG. 10C are other embodiments of the spectral characteristic data of the light sources having the spectral characteristics of the solid line 901 and the dotted line 902 in FIG. 10A, respectively. In this data, the intensity is written at every 10 nm wavelength respectively. It is preferable to use this type of spectral characteristic data when a light source, of which spectrum is wide, is used.

An example of reading the fixed spectral characteristic data from the ROM 203 was described, but Third embodiment is not limited to this type. For example, the CPU 202 may measure the operation time of the light source 201 and store this operation time in the ROM 203, so as to use the sensitivity characteristic data which is corrected by the aging deterioration coefficient acquired based on this operation time. This example will be described with reference to FIG. 6. In FIG. 6, the abscissa indicates the operation time of the light source 201, and the ordinate indicates the coefficient with respect to the intensity of the light emitted from the light source 201. The light source 201 deteriorates due to aging, hence the coefficient with respect to the intensity monotonically decreases. By storing this relationship in the ROM 203 in advance, the CPU 202 can determine the coefficient a from the operation time t of the light source 201. By multiplying the above mentioned spectral characteristic data by this coefficient a, the spectral characteristic data, considering the aging deterioration, can be acquired. In the case of the above mentioned example, if a=0.6, the intensity at 730 nm on the solid line is 0.90×0.6=0.54, and the intensity at 800 nm on the dotted line is 1.00×0.6=0.60. Further, a spectral sensor (not illustrated) may be disposed on the optical path between the light source 201 and the liquid crystal element 210IR, and the CPU 202 may read the measured value thereof, so as to directly acquire the spectral characteristic data. In this case, the above mentioned calculation of the aging deterioration is not necessary, hence the calculation volume is reduced.

Then in step S402, the CPU 202 corrects the brightness of the IR image based on the sensitivity characteristic data of the night vision goggles 107 acquired in step S400, and the spectral characteristic data of the IR light of the liquid crystal projector 100 acquired in step S401. This correction method will be described.

In step S402, the CPU 202 estimates the brightness of the output light of the night vision goggles. The output light of the night vision goggles is the light indicated by the spectral characteristic acquired in step S401, which is converted by the night vision goggles having the sensitivity characteristic data acquired in step S400. In concrete terms, the CPU 202 estimates the brightness value b of the output light of the night vision goggles 107 using the following expression.

$$b = {\sum }_{i = {w}_{0} , {w}_{1} , ⋯ , {w}_{n}} L ( i ) \cdot N ( i ) \qquad ( 1 )$$

Here w₀, w₁, . . . , wₙ indicate the wavelength at which the sensitivity characteristic data and the spectral characteristic data are defined. L(i) is a function to indicate the spectral characteristic data of the light source 201, and indicates the intensity of the light source 201 at the wavelength i. N(i) is a function to indicate the sensitivity characteristic data of the night vision goggles 107, and indicates the sensitivity of the night vision goggles 107 at the wavelength i. The sensitivity at a wavelength, which is not defined in step S400 in the sensitivity characteristic data, or the intensity at a wavelength which is not defined in step S401 in the spectral characteristic data, can be regarded as 0.00 respectively.

For example, in the case when the sensitivity characteristic data in FIG. 5C and the spectral characteristic data in FIG. 10C are acquired, the estimated brightness value is b=0.06×0.97+0.35×0.99+1.00×1.00+0.35×0.98+0.06×0.97=1.81.

The CPU 202 stores a target value in the ROM 203 in advance, so as to determine whether the acquired estimated brightness value b is lower or higher than the target brightness. In step S402, if the acquired sensitivity characteristic data is lower than the target brightness, the CPU 202 instructs the light source control unit 212 to increase the quantity of light of the light source 201. If the acquired sensitivity characteristic data is higher than the target brightness, on the other hand, the CPU 202 instructs the light source control unit 212 to decrease the quantity of light of the light source 201. In concrete terms, if the target value is 1.00 and the acquired sensitivity characteristic data is 1.81, for example, the CPU 202 instructs the light source control unit 212 to adjust the quantity of light of the light source 201 to 1.00/1.81=55%. In other words, the CPU 202 adjusts the quantity of light of the light source 201 so as to be the quantity of the light of the light source 201 determined by multiplying the quantity of light of the light source 201 before adjustment by the ratio of the target value to the estimated brightness value b.

The target value may be provided by a method other than the method of storing the value in the ROM 203 in advance. For example, the user (e.g. an administrator) of the training simulator may input the target value via the operation unit 205, and the CPU 202 may receive this value. As a method of correcting the brightness, a method other than the method of increasing/decreasing the quantity of the IR light irradiated from the liquid crystal projector 100 may be used. For example, the CPU 202 may instruct the image processing unit 208 to increase/decrease the gradation of the IR image. Or the CPU 202 may instruct the liquid crystal control unit 209 to increase/decrease the drive voltage of the liquid crystal element 2101R Or the members (not illustrated) to control the quantity of light such as diaphragm may be disposed on the optical path of the IR light, so that the CPU 202 controls these members to increase/decrease the quantity of light. Or the CPU 202 may instruct the night vision goggles 107, via the communication unit 216, to change the gain to convert the IR light into visible light. In this way, any means may be used as long as the brightness of the displayed IR image, observed via the night vision goggles 107, can be adjusted. After step S402, this flow ends.

According to Third embodiment, the brightness of the IR image is corrected, with considering the spectral characteristic of the light source 201 as well, in addition to First embodiment. For example, if the spectral characteristic data is acquired, the brightness close to the target brightness can be implemented using the multiplied value of the spectral characteristic data and the sensitivity characteristic data of the night vision goggles 107, even if the spectral characteristic of the light source 201 is for some reason abnormal.

According to Third embodiment, the liquid crystal projector 100 can control the quantity and brightness of the IR light, so as to minimize the change of the brightness of the view of the image via the night vision goggles, even if the devices deteriorate or are replaced during the training simulation. Therefore the administrator who maintains the training simulation system can adjust brightness more easily.

### Fourth Embodiment

This is an example when the liquid crystal projector in Third embodiment is modified. The differences from Third embodiment will be mainly described herein below, omitting description on common portions with Third embodiment.

(Characteristic Operation Flow of the Liquid Crystal Projector)

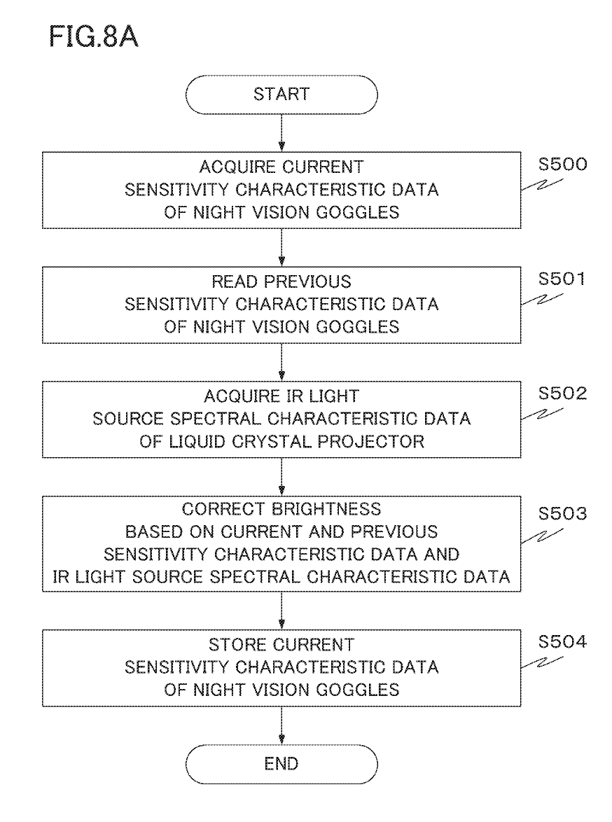

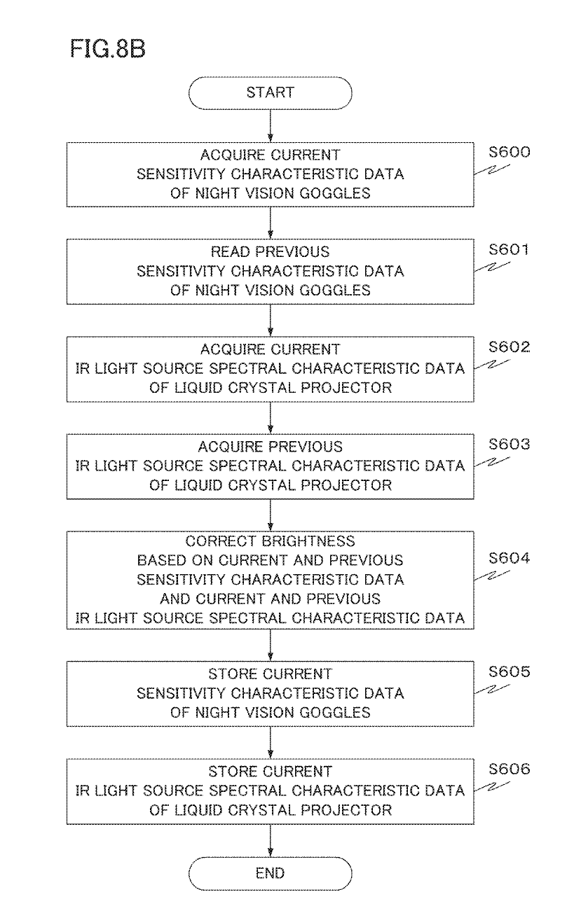

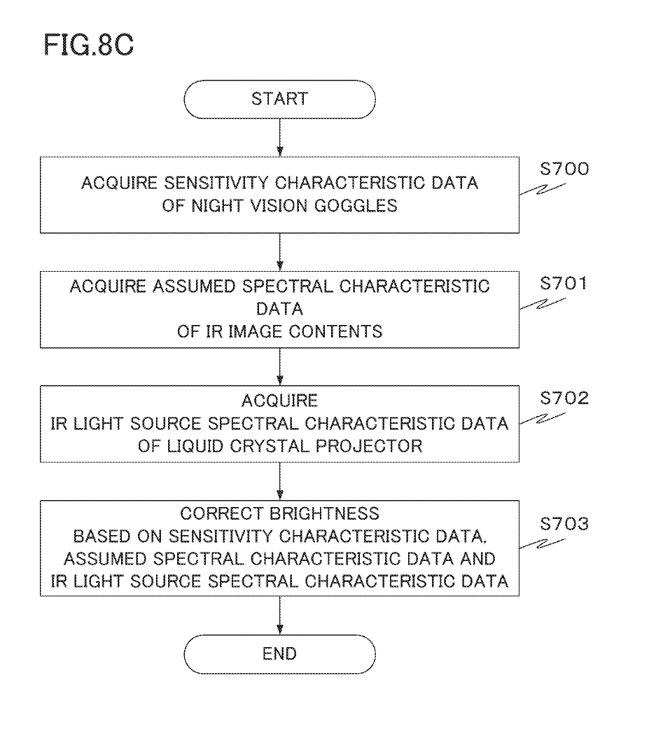

FIG. 8A is a modification of the operation flow of the CPU 202 of the liquid crystal projector 100. The start condition of this flow is the same as FIG. 7A of First embodiment. Step S500 is the same as step S400. In step S501, the CPU 202 reads the previous sensitivity characteristic data of the night vision goggles from the ROM 203. The previous sensitivity characteristic data is stored in the later mentioned step S504, and is a sensitivity characteristic data of the night vision goggles 107 when this flow was executed the last time. In the case when this flow is executed for the first time, the previous sensitivity characteristic data cannot be acquired, hence the target value described in step S201 in FIG. 7A of First embodiment, for example, is used. Step S502 is the same as step S401.

Then in step S503, the CPU 202 corrects the brightness of the IR image, based on the current sensitivity characteristic data of the night vision goggles 107, the previous sensitivity characteristic data of the night vision goggles 107, and the spectral characteristic data of the IR light of the liquid crystal projector 100. This correction method will be described next.

In step S503, the CPU 202 estimates the brightness of the light after the light, indicated by the spectral characteristic data acquired in step S502, is converted by the night vision goggles having the current sensitivity characteristic data acquired in step S500. This estimation method is the same as the method in step S402. Then the CPU 202 estimates the brightness of the light after the light indicated by the spectral characteristic data acquired in step S502 is converted by the night vision goggles having the previous sensitivity characteristic data acquired in step S501. In concrete terms, the estimated brightness value b′ of the previous output light of the night vision goggles 107 is estimated using the following expression, for example.

$${b}^{′} = {\sum }_{i = {w}_{0} , {w}_{1} , ⋯ , {w}_{n}} L ( i ) \cdot {N}^{′} ( i ) \qquad ( 2 )$$

Here w₀, w₁, . . . , wₙ indicate the wavelength at which the previous sensitivity characteristic data and the spectral characteristic data are defined. L(i) is a function to indicate the spectral characteristic data of the light source 201, and indicates the intensity of the light source 201 at the wavelength i. N′(i) is a function to indicate the previous sensitivity characteristic data of the night vision goggles 107, and indicates the sensitivity of the night vision goggles 107 at the wavelength i. The sensitivity and intensity at a wavelength which is not defined, in the previous or current sensitivity characteristic data or in the spectral characteristic data, can be regarded as 0.00 respectively.

If the current estimated brightness value b, which is determined in the same manner as Third embodiment, is lower than the previous estimated brightness value b′, the CPU 202 instructs the light source control unit 212 to increase the quantity of light of the light source 201. If the current estimated brightness value b is higher than the previous estimated brightness value b′, on the other hand, the CPU 202 instructs the light source control unit 212 to decrease the quantity of light of the light source 201. In concrete terms, if the previous estimated brightness value is b′=1.20 and the current estimated brightness value is b=1.00, the CPU 202 instructs the light source control unit 212 to adjust the quantity of light of the light source 201 to 1.20/1.00=120/%.

As a method of correcting the brightness, a method other than the method of increasing/decreasing the quantity of IR light irradiated from the liquid crystal projector 100 may be used. For example, the CPU 202 may instruct the image processing unit 208 to increase/decrease the gradation of the IR image. Or the CPU 202 may instruct the liquid crystal control unit 209 to increase/decrease the drive voltage of the liquid crystal element 210IR. Or members (not illustrated) to control the quantity of light such as diaphragm may be disposed on the optical path of the IR light, so that the CPU 202 controls these members to increase/decrease the quantity of light. Or the CPU 202 may instruct the night vision goggles 107, via the communication unit 216, to change the gain to convert the IR light into the visible light. In this way, any means may be used as long as the brightness of the displayed IR image, observed via the night vision goggles 107, can be adjusted.

Then in step S504, the CPU 202 stores the current sensitivity characteristic data of the night vision goggles 107 acquired in step S500 in the ROM 203. This sensitivity characteristic data is read by the CPU 202 as the previous sensitivity characteristic data, when this flow is executed the next time in step S501. After the step S504, this flow ends.

According to Fourth embodiment, the previous sensitivity characteristic data is also considered in addition to Third embodiment. In other words, with considering the spectral characteristic of the light source 201, a view, via the night vision goggles, which is similar to the point when the sensitivity characteristic data was previously acquired, can be implemented, even if the sensitivity characteristic of the night vision goggles 107 changed due to aging. The night vision goggles through which the previous sensitivity characteristic data is acquired may be the same as the current night vision goggles, or may be different night vision goggles from the current night vision goggles. When different night vision goggles are used, the view of the image via the night vision goggles can be implemented even if arbitrary night vision goggles are used.

According to Fourth embodiment, the liquid crystal projector 100 can control the quantity and brightness of the IR light, so as to minimize the change of the brightness of the view of the image via the night vision goggles, even if the devices deteriorate or are replaced during the training simulation. Therefore the administrator who maintains the training simulation system can adjust the brightness more easily.

### Fifth Embodiment

This is an example when the liquid crystal projector in Fourth embodiment is modified. Differences from Fourth embodiment will be mainly described herein below, omitting description on common portions with Fourth embodiment.

(Characteristic Operation Flow of the Liquid Crystal Projector)

FIG. 8B is a modification of the operation flow of the CPU 202 of the liquid crystal projector 100. The start condition of this flow is the same as FIG. 7A of First embodiment. Step S600 is the same as step S500. Step S601 is the same as step S501. Step S602 is the same as step S502. In step S603, the CPU 202 reads the previous spectral characteristic data of the light source 201 from the ROM 203. The previous spectral characteristic data is stored in the later mentioned step S606, and is a spectral characteristic data of the light source 201 when this flow was executed the last time. In the case when this flow is executed for the first time, the previous spectral characteristic data cannot be acquired, hence the spectral characteristic data measured before shipment is stored in the ROM 203 in advance, and is read and used. Or this flow may be modified so that steps S603 and S604 are skipped when this flow is executed for the first time.

Then in step S604, the CPU 202 corrects the brightness of the IR image, based on the current and previous sensitivity characteristic data of the night vision goggles 107 and the current and previous spectral characteristic data of the liquid crystal projector 100. This correct method will be described next.

In step S604, the CPU 202 estimates the brightness of the light after the light, indicated by the current spectral characteristic data acquired in step S602, is converted by the night vision goggles having the current sensitivity characteristic data acquired in step S600. This estimation method is the same as the method in step S503. Then the CPU 202 estimates the brightness of the light after the light indicated by the previous spectral characteristic data acquired in step S603 is converted by the night vision goggles having the previous sensitivity characteristic data acquired in step S601. In concrete terms, the previous estimated brightness value b″ of the output light of the night vision goggles 107 is estimated using the following expression, for example.

$${b}^{″} = {\sum }_{i = {w}_{0} , {w}_{1} , ⋯ , {w}_{n}} {L}^{′} ( i ) \cdot {N}^{′} ( i ) \qquad ( 3 )$$

Here w₀, w₁, . . . , wₙ indicate the wavelength at which the previous sensitivity characteristic data and the spectral characteristic data are defined. L′(i) is a function to indicate the previous spectral characteristic data of the light source 201, and indicates the previous intensity of the light source 201 at the wavelength i. N′(i) is a function to indicate the previous sensitivity characteristic data of the night vision goggles 107, and indicates the previous sensitivity of the night vision goggles 107 at the wavelength i. The sensitivity and intensity at a wavelength which is not defined, in the previous or current sensitivity characteristic data or in the previous or current spectral characteristic data, can be regarded as 0.00 respectively.

If the current estimated brightness value b is lower than the previous estimated brightness value b″, the CPU 202 instructs the light source control unit 212 to increase the quantity of the light of the light source 201. If the current estimated brightness value b is higher than the previous estimated brightness value b″, on the other hand, the CPU 202 instructs the light source control unit 212 to decrease the quantity of light of the light source 201. In concrete terms, if the previous estimated brightness value is b″=1.20 and the current estimated brightness value is b=1.00, the CPU 202 instructs the light source control unit 212 to adjust the quantity of light of the light source 201 to 1.20/1.00=120%.

As a method of correcting the brightness, a method other than the method of increasing/decreasing the quantity of IR light irradiated from the liquid crystal projector 100 may be used. For example, the CPU 202 may instruct the image processing unit 208 to increase/decrease the gradation of the IR image. Or the CPU 202 may instruct the liquid crystal control unit 209 to increase/decrease the drive voltage of the liquid crystal element 2101R. Or members (not illustrated) to control the quantity of light such as diaphragm may be disposed on the optical path of the IR light, so that the CPU 202 controls these members to increase/decrease the quantity of light. Or the CPU 202 may instruct the night vision goggles 107, via the communication unit 216, to change the gain to convert the IR light into the visible light. In this way, any means may be used, as long as the brightness of the displayed IR image, observed via the night vision goggles 107, can be adjusted.

Step S605 is the same as step S504. Then in step S606, the CPU 202 stores the current spectral characteristic data of the light source 201 acquired in step S602 in the ROM 203. This spectral characteristic data is read by the CPU 202 as the previous spectral characteristic data when this flow is executed the next time in step S603. After the step S606, this flow ends.

According to Fifth embodiment, the previous spectral characteristic data is also considered in addition to Fourth embodiment. In other words, a view of the image, via the night vision goggles, which is similar to the point when the spectral characteristic data was previously acquired, can be implemented, even if the spectral characteristic of the light source 201 changed due to aging.

According to Fifth embodiment, the liquid crystal projector 100 can control the quantity and brightness of the IR light, so as to minimize the change of the brightness of the view of the image via the night vision goggles, even if the devices deteriorate or are replaced during the training simulation. Therefore the administrator who maintains the training simulation system can adjust the brightness more easily.

The above described liquid crystal projector 100 may be further modified. This modification will be described herein below with reference to the system diagram in FIG. 1. In the above described examples, the CPU 202 acquires the previous sensitivity characteristic data and the previous spectral characteristic data from the ROM 203 respectively in step S601 and step S603. By modifying these steps, the CPU 202 may instruct to acquire each data from the server 110 connected to the network 109 via the communication unit 216. Further, in the above described examples, the CPU 202 stores the previous sensitivity characteristic data and the previous spectral characteristic data in the ROM 203 respectively in step S605 and step S606. By modifying these steps, the CPU 202 may instruct to store each data in the server 110 connected to the network 109 via the communication unit 216.

Then in the training simulation, the change of the brightness of the view of the image via the night vision goggles can be minimized, even if the liquid crystal projector is replaced, due to failure or the like, during the training simulation, and the previous sensitivity characteristic data or the previous spectral characteristic data stored in the ROM 203 is lost. Therefore the administrator who maintains the training simulation system can adjust the brightness more easily.

Furthermore, when the CPU 202 communicates with the server 110 to store the sensitivity characteristic data or the spectral characteristic data, an identifier of the currently displayed IR image may be sent as well, as a key to store this data. The server 110 stores this data using this identifier key. When the sensitivity characteristic data or the spectral characteristic data is acquired from the server 110, the CPU 202 sends the identifier of the currently displayed IR image to the server 110. The server 110 replies with the data corresponding to the identifier key. For the identifier of the image, a unique value (e.g. a digital hash value of the image, the Uniform Resource Identifier (URI) of the image), the characteristic value of the image and the like can be used. Moreover, in addition to the case where each data is stored or read to/from the server 110, this example can be applied to another device that can store and read data. For example, the CPU 202 may similarly store or read data to/from a USB flash memory via the communication unit 216.

If this modification is used, the change of the brightness of the view of the image via the night vision goggles, depending on the image data, can be minimized, even if devices deteriorate or are replaced during the training simulation. Therefore the administrator who maintains the training simulation system can adjust the brightness more easily. Further, in addition to the identifier of the image, an identifier of the liquid crystal projector 100 may be included as a key. In this case, the change of the brightness can be minimized only when the same liquid crystal projector is used.

### Sixth Embodiment

This is an example when the liquid crystal projector in Third embodiment is modified. The differences from Third embodiment will be mainly described herein below, omitting description on common portions with Third embodiment.

(Characteristic Operation Flow of Liquid Crystal Projector)

FIG. 8C is a modification of the characteristic flow of the CPU 202 of the liquid crystal projector 100. The start condition of this flow is the same as FIG. 7A of First embodiment. Step S700 is the same as step S400. In step S701, the CPU 202 acquires the spectral characteristic data that is assumed for the contents of the IR image to be input to the liquid crystal projector 100. “The contents spectral characteristic data” is an assumed wavelength of the IR light when this IR image is actually displayed, and is determined when the IR image contents are created. In concrete terms, when the contents are projected as a projection image, the contents spectral characteristic data indicates the spectral characteristic of the projected image. For example, if the IR image was created by computer graphics (CG), the contents spectral characteristic data is designed by a designer of the IR image. If the IR image was captured by an IR camera, the contents spectral characteristic data is the spectral sensitivity characteristic of the IR camera. By using the contents spectral characteristic data, the image can be calibrated, for example. Calibration is possible by correcting the brightness of the contents image projected by the liquid crystal projector 100 to the brightness included in the contents spectral characteristic data.

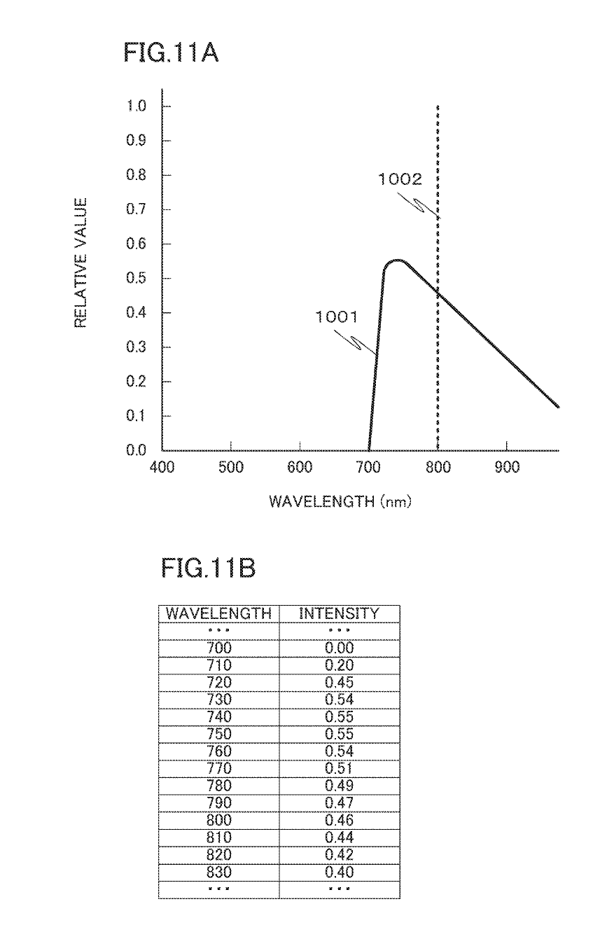

A concrete example of the contents spectral characteristic data will be described with reference to FIG. 11A and FIG. 11B. FIG. 11A is a graph depicting the spectral characteristic of an IR image. The abscissa indicates the wavelength, and the ordinate indicates a normalized intensity of the IR light that is assumed when this IR image is displayed. The solid line 1001 and the dotted line 1002 in FIG. 11A were generated by plotting the two different types of contents spectral characteristic as examples.

For the contents spectral characteristic data, the wavelength at which the intensity is peak and a value of this intensity can be used. For example, in the case of the characteristic indicated by the dotted line in FIG. 11A, the contents spectral characteristic data, in which the wavelength is 800 nm and intensity is 1.00, can be used. If this type of contents spectral characteristic data is used for artificially created contents, such as by CG, the number of steps of designing the contents can be decreased. Another modified type of contents spectral characteristic data may be used, and, for example, only the peak wavelength may be used as the contents spectral characteristic data. In this case, the intensity corresponding to this wavelength is regarded as a predetermined value, such as 1.00, and subsequent processing is performed, whereby this type can be applied to Sixth embodiment in the same manner as above.

Data other than the above may be used for the contents spectral characteristic data. For example, if the characteristic is as indicated by the solid line 1001 in FIG. 11A, the contents spectral characteristic data in FIG. 11B can be used. In this data, intensity is indicated at each 10 nm wavelength. If this type of contents spectral characteristic data is used when the IR image contents are captured by the IR camera, the characteristic captured by the camera can be transferred to the display device, whereby information, to display the image with a characteristic similar to the characteristic at image capturing, can be generated.

The contents spectral characteristic data is stored, for example, during a blanking period of the image data including the IR image, which the personal computer 101 transfers via the video cable 103. In step S701, the CPU 202 instructs the IR image inputting unit 207 to acquire the contents spectral characteristic data during the blanking period of the image data including the IR image.

As a method of acquiring the contents spectral characteristic data, another method may be used in Sixth embodiment. For example, the user may input the contents spectral characteristic data using the operation unit 205. The CPU 202 may request an external device, such as an image data managing server via the communication unit 216, to send the contents spectral characteristic data, so as to acquire the contents spectral characteristic data. Step S702 is the same as step S401.

Then in step S703, the CPU 202 corrects the brightness of the IR image based on the sensitivity characteristic data of the night vision goggles 107, the contents spectral characteristic data and the spectral characteristic data of the IR light of the liquid crystal projector 100. The correction method will be described.

In step S703, the CPU 202 estimates the brightness of the light after the light, indicated by the spectral characteristic data acquired in step S702, is converted by the night vision goggles having the sensitivity characteristic data acquired in step S700. This estimation method is the same as the method in step S402. Then the CPU 202 estimates the brightness of the light after the light indicated by the contents spectral characteristic data acquired in step S701 is converted by the night vision goggles having the sensitivity characteristic data acquired in step S700. In concrete terms, the estimated brightness value b′″ is estimated using the following expression, for example.

$${b}^{′′′} = {\sum }_{i = {w}_{0} , {w}_{1} , ⋯ , {w}_{n}} C ( i ) \cdot N ( i ) \qquad ( 4 )$$

Here w₀, w₁, . . . . wₙ indicate the wavelength at which the sensitivity characteristic data and the contents spectral characteristic data are defined. C(i) is a function to indicate the contents spectral characteristic data, and indicates the intensity at the wavelength i. N(i) is a function to indicate the sensitivity characteristic data of the night vision goggle 107, and indicates the sensitivity of the night vision goggle 107 at the wavelength i. The sensitivity and intensity at a wavelength, which is not defined among the sensitivity characteristic data or the contents spectral characteristic data, can be regarded as 0.00 respectively.

If the estimated brightness value b when projection is perform without correction is lower than the estimated brightness value b′″ when the light assumed in the contents is observed by the night vision goggles 107, the CPU 202 instructs the light source control unit 212 to increase the quantity of light of the light source 201. If the estimated brightness value b is higher than the estimated brightness value b′″, on the other hand, the CPU 202 instructs the light source control unit 212 to decrease the quantity of the light source 201. In concrete terms, if the estimated brightness value is b′″=1.20 and the estimated brightness value is b=1.00, the CPU 202 instructs the light source control unit 212 to adjust the quantity of light of the light source 201 to 1.20/1.00=120%.

As a method of correcting the brightness, a method other than the method of increasing/decreasing the quantity of IR light irradiated from the liquid crystal projector 100 may be used. For example, the CPU 202 may instruct the image processing unit 208 to increase/decrease the gradation of the IR image. Or the CPU 202 may instruct the liquid crystal control unit 209 to increase/decrease the drive voltage of the liquid crystal element 210IR. Or members (not illustrated) to control the quantity of light such as diaphragm may be disposed on the optical path of the IR light, so that the CPU 202 controls these members to increase/decrease the quantity of light. Or the CPU 202 may instruct the night vision goggles 107, via the communication unit 216, to change the gain to convert the IR light into visible light. In this way, any means may be used as long as the brightness of the displayed IR image, observed via the night vision goggles 107, can be adjusted. Then this flow ends.

According to Sixth embodiment, the brightness of the IR image is corrected considering the spectral characteristic data of the contents. Therefore according to Sixth embodiment, the brightness of the IR image is corrected so that the brightness of the image, observed via the night vision goggles 107, becomes the brightness intended by the creator of the contents.

In the training simulation, the user may feel discomfort about the brightness of the night vision goggles 107 at initial installation, or when such a device as a liquid crystal projector is replaced. In concrete terms, in the above mentioned case, the spectral characteristic of the light output by the light source 201 of the liquid crystal projector 100 is different from the spectral characteristic of the assumed IR light in the IR image that is used for the training, whereby light with an unexpected brightness may be observed via the night vision goggles 107. According to Sixth embodiment, the liquid crystal projector 100 can control the quantity and brightness of the IR light, so that the brightness of the view of the image via the night vision goggles becomes similar to the assumed brightness. As a result, the administrator who installs the training simulation system can adjust the brightness more easily.

### Other Embodiments

The present invention may be implemented by a processing in which a program to implement at least one function of the above examples is supplied to a system or an apparatus via a network or a storage medium, and at least one processor in the computer of the system or the apparatus reads and executes the program. The present invention may also be implemented by a circuit (e.g. ASIC) that implements at least one function of the above examples.

Examples 1 to 6 are merely examples, and configurations that are implemented by appropriately modifying or changing the configurations of Examples 1 to 6 within the scope of the essence of the invention are also included in the invention. Configurations that are implemented by appropriately combining the configurations of Examples 1 to 6 are also included in the invention.

For example, in each of the examples described above, the projection apparatus (processor in the projection apparatus) executes the control to change the quantity of light in accordance with the conversion characteristic of the goggles, but an external control device connected to the projection apparatus may control the changes of the quantity of light of the projection apparatus. In the case of this configuration, the control device can have at least a function to acquire the device information of the goggles, and a function to control the quantity of light of the projection apparatus in accordance with the conversion characteristic of the goggles, based on the device information. These functions may be implemented as software, by the processor in the control device executing the program, or may be implemented by a hardware circuit (e.g. ASIC) incorporated in the control device. For the control device, the personal computer 101 in FIG. 1 may be used, for example, or a smartphone, a tablet terminal, a video output device and the like may be used. The projection apparatus and the control device may be connected by a cable or wirelessly.

Further, in each of the examples described above, the quantity of light of the projection apparatus is changed in accordance with the conversion characteristic of the goggles, but an external control device connected to the projection apparatus may perform control to change the characteristic of the image data to be sent to the projection apparatus in accordance with the conversion characteristic of the goggles. In this way, the object and effect similar to each of the examples described above can be implemented by changing the characteristic (e.g. brightness) of the image data provided to the projection apparatus, in accordance with the conversion characteristic of the goggles. In the case of this configuration, the control device can have at least a function to acquire the device information of the goggle, and a function to select image data having a characteristic which is suitable for the conversion characteristic of the goggle based on this device information, and output this image data to the projection apparatus. These functions may be implemented as software by the processor in the control device executing the program, or may be implemented by a hardware circuit (e.g. ASIC) incorporated in the control device. For the control device, the personal computer 101 in FIG. 1 may be used, for example, or a smartphone, a tablet terminal, a video output device and the like may be used. The projection apparatus and the control device may be connected by a cable or wirelessly.

In the examples described above, the previous sensitivity characteristic data of the night vision goggles and the previous spectral characteristic data of the liquid crystal projector were used. Further, in the examples described above, as an example, the night vision goggles which acquire the current sensitivity characteristic data and the night vision goggles which acquire the previous sensitivity characteristic data are essentially the same. Also, the liquid crystal projector which acquires the current spectral characteristic data and the liquid crystal projector which acquires the previous spectral characteristic data are essentially the same. However, the current data and the previous data may be acquired from different night vision goggles or from different liquid crystal projectors. The previous sensitivity characteristic data and the previous spectral characteristic data may be stored in an external server, for example, or may be stored in the liquid crystal projection that is currently used. Thereby when arbitrary night vision goggles and an arbitrary liquid crystal projector are used, a view of the image via the night vision goggles can be reproduced using different night vision goggles and liquid crystal projector.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-085241, filed on Apr. 24, 2017, which is hereby incorporated by reference herein in its entirety.

What is claimed is:

1. A projection apparatus that projects a projection image of invisible light onto a projection plane, the projection apparatus comprising:
a light source configured to emit light including invisible light;
a projecting unit configured to project the projection image by modulating light emitted from the light source based on input image data;
a first acquiring unit configured to acquire first characteristic information indicating a wavelength conversion characteristic of goggles that convert a wavelength of the projection image and output an image of visible light to a user; and
an adjusting unit configured to adjust brightness of the projection image on the projection plane based on the first characteristic information.

2. The projection apparatus according to claim 1, wherein
the adjusting unit is further configured to adjust, based on the first characteristic information, the brightness of the projection image on the projection plane to be higher as an efficiency for the goggles to convert the wavelength of the invisible light into a wavelength visible to the user is lower.

3. The projection apparatus according to claim 1, wherein
the adjusting unit is further configured to adjust the brightness of the projection image by adjusting a quantity of light of the light source.

4. The projection apparatus according to claim 1, wherein
the projecting unit includes a transmission panel configured to transmit, at a transmittance based on the input image data, the light emitted from the light source, and
the adjusting unit is further configured to adjust the brightness of the projection image by adjusting the transmittance of the transmission panel.

5. The projection apparatus according to claim 1, wherein
the first acquiring unit is further configured to acquire device information including individual information for specifying an individual unit of the goggles, or type information for identifying a model number of the goggles, and acquire the first characteristic information based on the device information.

6. The projection apparatus according to claim 1, further comprising a second acquiring unit configured to acquire first spectral information indicating a spectral characteristic of the light emitted from the light source, wherein
the adjusting unit is further configured to adjust the brightness of the projection image based on the first characteristic information and the first spectral information.

7. The projection apparatus according to claim 6, wherein
the first characteristic information is a value that indicates a relationship between a wavelength of light input to the goggles and a conversion efficiency,
the first spectral information is a value that indicates a relationship between the wavelength and intensity of the light emitted by the light source, and
the adjusting unit is further configured to adjust the brightness of the projection image based on a multiplied value of the first characteristic information by the first spectral information, and a target value.

8. The projection apparatus according to claim 6, wherein
the second acquiring unit is further configured to acquire second spectral information indicating a spectral characteristic of an image in which contents of the input image data is projected by the projecting unit, and
the adjusting unit is further configured to adjust the brightness of the projection image based on the first characteristic information, the first spectral information, and the second spectral information.

9. The projection apparatus according to claim 8, wherein
the adjusting unit is further configured to adjust a quantity of the modulated light so as to be a quantity of light determined by multiplying the quantity of light before adjustment by a ratio of a second multiplied value obtained by multiplying the first characteristic information and the second spectral information, to a first multiplied value obtained by multiplying the first characteristic information and the first spectral information.

10. The projection apparatus according to claim 6, wherein
the first acquiring unit is further configured to acquire second characteristic information which is different from the first characteristic information, and
the adjusting unit is further configured to adjust the brightness of the projection image based on the first characteristic information, the second characteristic information, and the first spectral information.

11. The projection apparatus according to claim 1, wherein
the first acquiring unit is further configured to acquire the first characteristic information and second characteristic information which is different from the first characteristic information, and
the adjusting unit is further configured to adjust the brightness of the projection image based on the first characteristic information and the second characteristic information.

12. The projection apparatus according to claim 11, wherein
the second characteristic information is a conversion characteristic which has been previously acquired using goggles in which the first characteristic information has been acquired, or a conversion characteristic which has been acquired using goggles which are different from the goggles in which the first characteristic information has been acquired.

13. A control device that controls a projection apparatus which includes a light source configured to emit light including invisible light, and a projecting unit configured to project a projection image by modulating light emitted from the light source based on input image data, the control device comprising:
a first acquiring unit configured to acquire first characteristic information indicating a wavelength conversion characteristic of goggles that convert a wavelength of the projection image and output an image of visible light to a user; and
a controlling unit configured to control at least one of the light source and the projecting unit, so as to adjust brightness of the projection image on the projection plane based on the first characteristic information.

14. A control method for a projection apparatus that includes a light source configured to emit light including invisible light components, and projects a projection image of invisible light onto a projection plane, the control method comprising:
a projecting step of projecting the projection image by modulating light emitted from the light source based on input image data;
a first acquiring step of acquiring first characteristic information indicating a wavelength conversion characteristic of goggles that convert a wavelength of the projection image and output an image of visible light to a user; and
an adjusting step of adjusting brightness of the projection image on the projection plane based on the first characteristic information.

15. The control method for a projection apparatus according to claim 14, wherein
in the adjusting step, the brightness of the projection image on the projection plane is adjusted based on the first characteristic information, so as to be higher as a conversion efficiency for the goggles to convert the wavelength of the invisible light into a wavelength visible to the user is lower.

16. The control method for a projection apparatus according to claim 14, wherein
in the adjusting step, the brightness of the projection image is adjusted by adjusting a quantity of light of the light source.

17. The control method for a projection apparatus according to claim 14, wherein
in the projecting step, a transmission panel configured to transmit, at a transmittance based on the input image data, the light emitted from the light source is used, and
in the adjusting step, the brightness of the projection image is adjusted by adjusting the transmittance of the transmission panel.

18. The control method for a projection apparatus according to claim 14, wherein
in the first acquiring step, device information including individual information for specifying an individual unit of the goggles, or type information for identifying a model number of the goggles is acquired, and the first characteristic information is acquired based on the device information.

19. A control method for a control device that controls a projection apparatus which includes a light source configured to emit light including invisible light, and a projecting unit configured to project a projection image by modulating light emitted from the light source based on input image data, the control method comprising:
a first acquiring step of acquiring first characteristic information indicating a wavelength conversion characteristic of goggles that convert a wavelength of the projection image and output an image of visible light to a user; and
a controlling step of controlling at least one of the light source and the projecting unit, so as to adjust brightness of the projection image on the projection plane based on the first characteristic information.

20. A non-transitory computer readable medium that stores a program, wherein the program causes a computer to execute: a control method for a projection apparatus that includes a light source configured to emit light including invisible light components, and projects a projection image of invisible light onto a projection plane, the control method comprising:
a projecting step of projecting the projection image by modulating light emitted from the light source based on input image data;
a first acquiring step of acquiring first characteristic information indicating a wavelength conversion characteristic of goggles that convert a wavelength of the projection image and output an image of visible light to a user; and
an adjusting step of adjusting brightness of the projection image on the projection plane based on the first characteristic information.
